(19) United States
(12) Patent Application Publication
(10) Pub. No.: US 2007/0183516 A1
(43) Pub. Date: Aug. 9, 2007

(54) Wireless communications system employing OFDMA and CDMA techniques

(76) Inventors: Pantelis Monogioudis, Randolph, NJ (US); Shirish Nagaraj, Cedar Knolls, NJ (US); Harish Viswanathan, Morristown, NJ (US)

Correspondence Address: Lucent Technologies Inc.;Docket Administrator, Room 3J-219, 101 Crawfords Corner Road, Holmdel, NJ, 07733-3030, US

(21) Appl. No.: 11/332,643

(22) Filed: Jan. 13, 2006

(51) Int. Cl. H04K 1/10

(52) U.S. Cl. 375/260

(57) ABSTRACT

Disclosed is an Orthogonal Frequency Division Multiple Access (OFDMA) based wireless communications system operable to communicate OFDMA type signals over a set of dynamically assigned orthogonal sub-carriers and Code Division Multiple Access (CDMA) type signals over a set of pre-allocated orthogonal sub-carriers. The OFDMA system utilizes pre-allocated orthogonal sub-carriers for CDMA type signal transmission in order to reduce the number of dynamic assignments of orthogonal sub-carriers in a typical OFDMA system. The OFDMA type signals may be signals processed in accordance with well-known OFDMA techniques, whereas the CDMA type signals may be signals processed in accordance with well-known CDMA and OFDMA techniques. The CDMA type signals may also be processed using a pre-coder incorporating a Discrete Fourier Transformer (DFT) matrix or Identity matrix to reduce the Peak-to-Average Power Ratio across the OFDMA system.

### FIELD OF THE INVENTION

The present invention relates generally to wireless communications network and, in particular, to wireless communications network employing orthogonal frequency division multiple access techniques.

### BACKGROUND

Orthogonal Frequency Division Multiple Access (OFDMA) has emerged as the leading multiple access technique for next generation wireless communications systems. OFDMA systems are multi-carrier systems in which a bandwidth is divided into a set of orthogonal sub-carriers. The set of orthogonal sub-carriers are further sub-divided into subsets, wherein each subset of orthogonal sub-carriers forms a traffic channel. Each traffic channel can be assigned exclusively to a single user.

FIG. 1 depicts a transmitter 100 used in an OFDMA system in accordance with the prior art. Transmitter 100 comprises a modulator 110, a serial-to-parallel (S2P) converter 120, an Inverse Fast Fourier Transformer (IFFT) module 130, a cyclic prefix inserter 140, and a time domain filter 150. IFFT module 130 includes N ports for receiving modulation symbols. Each of the ports is associated with an orthogonal sub-carrier. IFFT module 130 is operable to use an N×N IFFT matrix to perform an transform operation on its inputs, wherein the entries of the matrix F_{j,k} are defined as F_{j,k}=e^{-2πijk/n},j,k=0, 1, 2, . . . , n−1 and i=\sqrt{−1}.

Encoded data symbols are provided as input to modulator 110. Modulator 110 uses well-known modulation techniques, such as BPSK, QPSK, 8 PSK, 16 QAM and 64 QAM, to convert the encoded data symbols into K modulation symbols Sₖ which are then provided as input to S2P converter 120, where K≦<=N. S2P converter 120 outputs parallel streams of modulation symbols which are provided as inputs to one or more ports of IFFT module 130 associated with orthogonal sub-carriers over which the encoded data symbols are to be transmitted. In IFFT module 130, an inverse fast Fourier transformation is applied to the modulation symbols Sₖ to produce a block of chips cₙ, where n=0, . . . , N−1. Cyclic prefix inserter 140 copies the last N_{cp} chips of the block of N chips and prepends them to the block of N chips producing a prepended block. The prepended set is then filtered through time domain filter 150 and subsequently modulated onto a carrier before being transmitted.

Compared to its predecessor systems, OFDMA systems enables a more efficient use of bandwidth allocation with increased tolerance to noise and multi-path. OFDMA systems, however, do have several disadvantages. One such disadvantage is that a considerable amount of its forward link capacity is utilized for overhead signaling of reverse link sub-carrier assignments. In OFDMA systems, reverse link sub-carrier assignments are not static. Users are dynamically assigned or reassigned sub-carriers on the reverse link depending on factors such as channel conditions, available resources and type of service. Each assignment and reassignment requires a channel assignment message to be sent over the forward link, wherein the channel assignment indicates the sub-carriers being assigned. Due to this dynamic nature of reverse link channel assignment, the volume of channel assignment messages increase which, in turn, consumes a considerable amount of the forward link capacity.

One other disadvantage is that OFDMA systems have a high peak-to-average power ratio (PAPR) compared to single carrier systems. When IFFT module 130 performs a transform operation on modulation symbols Sₖ, the result is a block of N chips Cₙ=ΣSₖ(a)e^{-i2πjk/N}^{_{FFT}}, which is a phase weighted sum of modulation symbols Sₗ, . . . S_{K}, wherein Sₖ(a) represents the amplitude of modulation symbol Sₖ. Since each chip cₙ, is essentially a combination of each of the modulation symbols, the amplitude associated with each chip cₙ, would be higher compared to its average amplitude over time resulting in a higher PAPR of transmitted waveforms. Multi-carrier systems with higher PAPR require higher rating power amplifiers and have inferior link budgets resulting in coverage limitations, as compared to single carrier systems.

Accordingly, there exists a need for reducing the amount of overhead signaling on the forward link and lowering the PAPR in OFDMA systems.

### SUMMARY OF THE INVENTION

The present invention is an Orthogonal Frequency Division Multiple Access (OFDMA) based wireless communications system operable to communicate OFDMA type signals over a set of dynamically assigned orthogonal sub-carriers and Code Division Multiple Access (CDMA) type signals over a set of pre-allocated orthogonal sub-carriers. Advantageously, the present invention OFDMA system utilizes pre-allocated orthogonal sub-carriers for CDMA type signal transmission in order to reduce the number of dynamic assignments of orthogonal sub-carriers and overhead signaling associated therewith in a typical OFDMA system. In one embodiment, the OFDMA type signals may be signals generated in accordance with well-known OFDMA techniques, whereas the CDMA type signals may be signals generated in accordance with well-known CDMA and OFDMA techniques. The CDMA type signals may also be processed using a pre-coder incorporating a Discrete Fourier Transformer (DFT) matrix to reduce the Peak-to-Average Power Ratio of transmitted waveforms. In other embodiments, the pre-coder may be bypassed and effectively replaced by an identity matrix, or the pre-coder may incorporate a matrix which depends on the frequency domain channel.

### BRIEF DESCRIPTION OF THE DRAWINGS

The features, aspects, and advantages of the present invention will become better understood with regard to the following description, appended claims, and accompanying drawings where:

FIG. 1 depicts a transmitter used in an OFDMA system in accordance with the prior art;

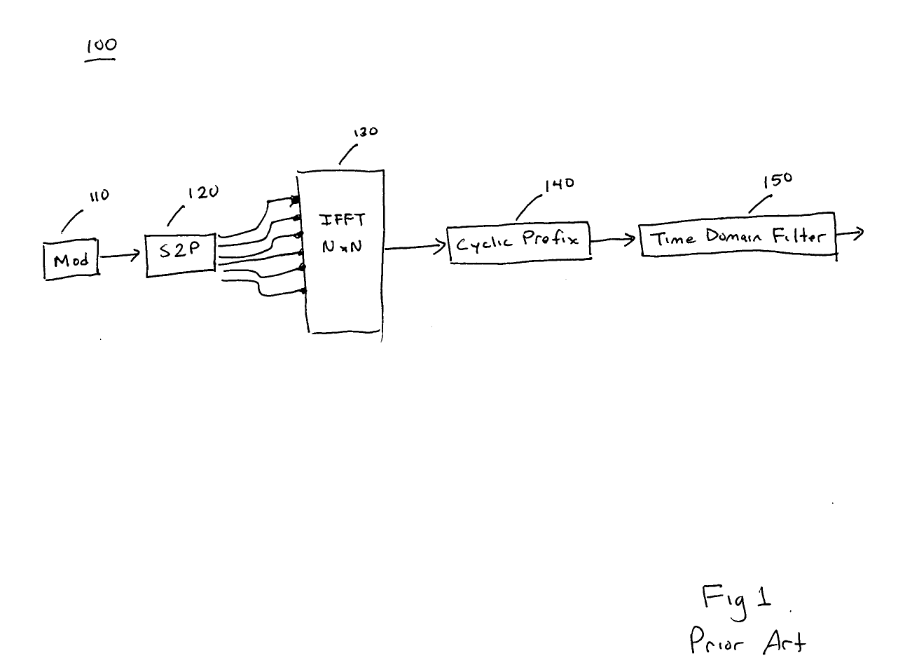

FIG. 2 depicts a bandwidth allocation for use in the OFCDMA system of the present invention; and

FIG. 3 depicts an schematic diagram of transmitter for use in the wireless communications system of the present invention.

### DETAILED DESCRIPTION

The present invention is an Orthogonal Frequency Division Multiple Access (OFDMA) wireless communications system operable to communicate OFDMA type signals over a set of dynamically assigned orthogonal sub-carriers and Code Division Multiple Access (CDMA) type signals over a set of pre-allocated orthogonal sub-carriers, wherein OFDMA type signals are signals generated in accordance with well-known OFDMA techniques and CDMA type signals are signals generated in accordance with well-known CDMA and OFDMA techniques. Advantageously, CDMA type signals are transmitted over pre-allocated orthogonal sub-carriers and, thus, do not require the dynamic assignment of orthogonal resources (e.g. sub-carriers). Preferably, CDMA type signals are signals associated with users with bursty and periodic traffic patterns.

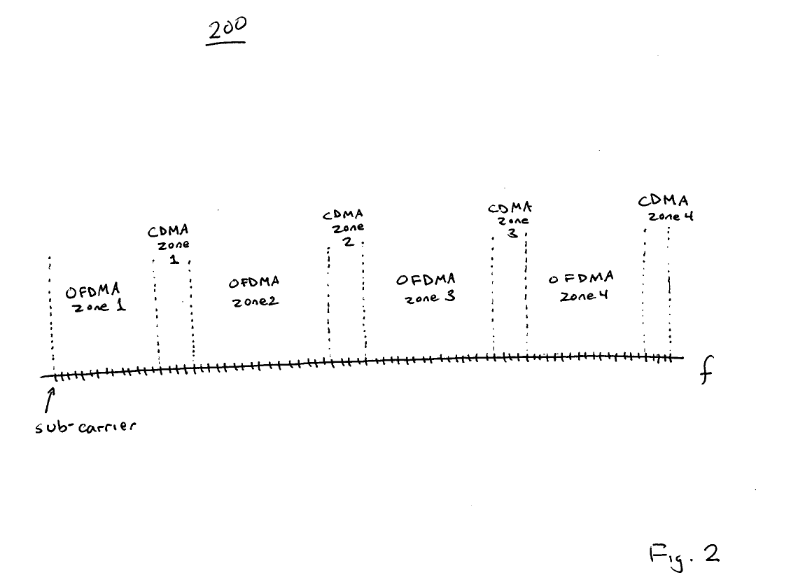

The OFDMA system of the present invention is a multi-carrier system in which a bandwidth is divided into a set of orthogonal sub-carriers. FIG. 2 depicts a bandwidth allocation 200 for use in the OFCDMA system of the present invention. As shown in FIG. 2, a bandwidth is divided into a set of orthogonal sub-carriers. The set of orthogonal sub-carriers are categorized into two groups. The first group, referred to herein as OFDMA group, comprises of orthogonal sub-carriers used for the transmission of OFDMA signals. The second group, referred to herein as CDMA group, comprises of orthogonal sub-carriers used for the transmission of CDMA type signals. The OFDMA and CDMA groups include one or more sub-groups referred to herein as OFDMA and CDMA zones, respectively. Each zone includes at least one orthogonal sub-carrier. In one embodiment, the CDMA zones are non-adjacent to each other and equidistant apart from its neighboring CDMA zones. In another embodiment, the CDMA zones can be adjacent to each other. In yet another embodiment, the CDMA zones may occupy the entire bandwidth, i.e., no OFDMA zones.

A traffic channel comprising of orthogonal sub-carriers in the OFDMA group is referred to herein as an OFDMA traffic channel, whereas a traffic channel comprising of orthogonal sub-carriers in the CDMA group is referred to herein as an CDMA traffic channel. As mentioned earlier, OFDMA type signals are signals generated in accordance with well-known OFDMA techniques, and CDMA type signals are signals generated in accordance with well-known CDMA and OFDMA techniques. In another embodiment, OFDMA type signals may be signals generated in accordance with the well-known Interleaved Frequency Division Multiple Access (IFDMA) technique, or any type of technique for generating signals over a Frequency Division Multiple Access (FDMA) system. Similarly, the CDMA type signals may be generated in accordance with only CDMA techniques, or with CDMA and IFDMA techniques.

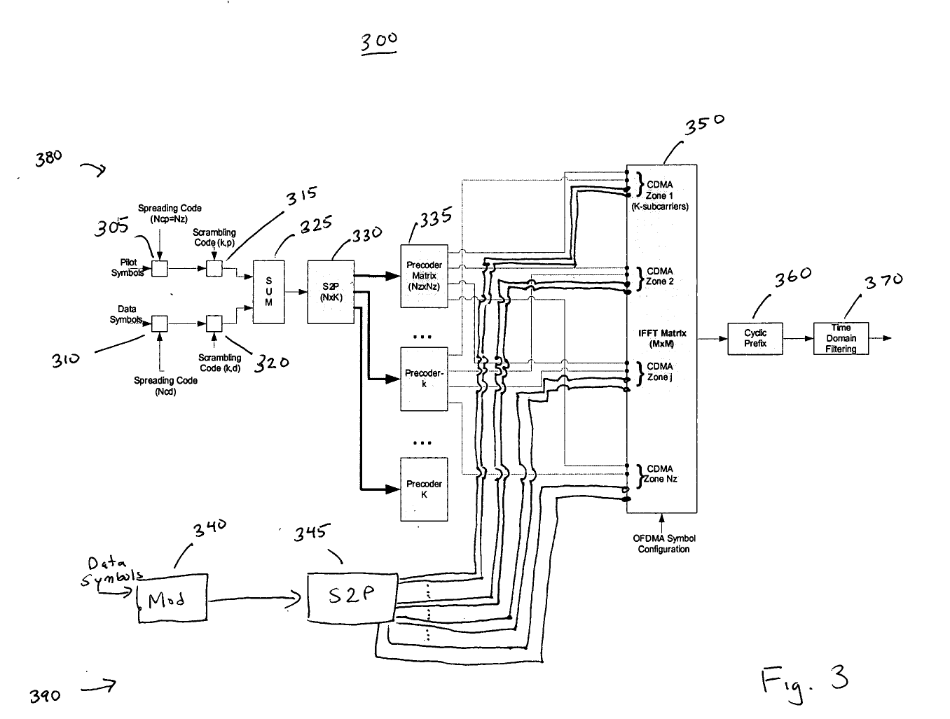

FIG. 3 depicts a schematic diagram of transmitter 300, in accordance with one embodiment, for use in the wireless communications system of the present invention. Transmitter 300 comprises a first portion 380 for processing CDMA type signals, and a second portion 390 for processing OFDMA type signals. First portion 380 comprises multipliers 305, 310, 320, 325, summer 325, serial-to-parallel (S2P) converter 330, a K pre-coders 335, Inverse Fast Fourier Transform (IFFT) module 350, cyclic prefix inserter 360, and time domain filter 370. Second portion 390 comprises modulator 340, S2P converter 345, IFFT module 350, cyclic prefix inserter 360 and time domain filter 370. Pre-coders 335 are operable to use a Discrete Fourier Transform (DFT) matrix or a matrix based on the frequency domain channel to perform a transform operation on its inputs. Each pre-coder 335 has N_{z} output ports. IFFT module 350 is operable to use an IFFT matrix to perform a transform operation on its inputs. IFFT module 350 has N_{FFT} input ports, wherein the N_{FFT} input ports include K×N_{z} ports associated with orthogonal sub-carriers belonging to CDMA zones, and N_{FFT}-K×N_{z} input ports associated with orthogonal sub-carriers belonging to OFDMA zones.

In first portion 380, pilot symbols and encoded data symbols are provided as inputs into multipliers 305, 310. The pilot and encoded data symbols are spread using spreading codes, such as Walsh codes, with spreading factors N_{cp} and N_{cd}, respectively. In one embodiment, spreading factor N_{cp} is equal to N_{z}, which is the number of CDMA zones in the wireless communications system. The spread pilot and data symbols are subsequently scrambled in multipliers 315, 320 using a pilot and a data scrambling code, such as Pseudo-random Noise (PN) codes, to produce pilot and data chips, respectively, wherein the scrambling codes have a period N and N>>N_{cp},N_{cd}. The scrambling codes may be CDMA zone specific. Additionally, the scrambling codes may have different offsets for the pilot and data branches of first portion 380. The pilot and data chip streams are code multiplexed in summer 325 to produce a code multiplexed signal, wherein the code multiplexed signal comprises of K×N_{z} code multiplexed chips. In another embodiment, the pilot and data chip streams are time multiplexed. For purposes of this application, a CDMA type signal may be construed to be the code or time multiplexed chip signal or any signal derived from the code or time multiplexed chip signal.

The code multiplexed signal is provided as input to S2P converter 330 where it distributes the code multiplexed chips equally among K pre-coders 335. In one embodiment, the code multiplexed chips may be provided as a block of N_{z} code multiplexed chips. For example, the first N_{z} code multiplexed chips are provided as input to the first pre-coder 335, the next N_{z} code multiplexed chips are provided as input to the second pre-coder 335, and so on. In another embodiment, the S2P converter 330 may distribute the code multiplexed chips unevenly among K or less pre-coders, and the block of code multiplexed chips may be a size different from N_{z}.

Pre-coders 335 use a matrix to perform a transform operation on an input vector in the time domain into a vector in the frequency domain. Note that the input and output vectors of pre-coders 335 comprise of N_{z} elements or chips. In one embodiment, pre-coders 335 are Discrete Fourier Transformers (DFT) which use a DFT matrix F of size N_{z} xN_{z} to transform the input vector comprising of the N_{z} code multiplexed chips from the time domain to the frequency domain, wherein the entries for matrix F are defined as F_{j,k} =e^{-i2πjk/N}^{_{z}},j,k=0,1,2, . . . , n−1 and i=\sqrt{−1}. If the code multiplexed chips at the input of DFT pre-coder are defined as vector s, where S=[S₁, S₂, S₃, . . . ,S_{Nz}]^{T} and T denotes the transpose operation, the output of DFT pre-coder can be defined as vector x, where

$$x = \frac{1}{\sqrt{{N}_{z}}} Fs = {[ {x}_{1} , … , {x}_{{N}_{z}} ]}^{T}$$

and comprises of N_{z} pre-coded elements or chips. In other embodiments, pre-coders 335 may use an identity matrix to transform the code multiplexed chips into the frequency domain from the time domain. Additionally, pre-coders 335 may use a matrix which is channel sensitive allowing for pre-equalization techniques to be applied to the transformation.

In one embodiment, each of the N_{z} output ports of the K pre-coders 335 are separately mapped to ports of IFFT 350 associated with orthogonal sub-carriers belonging to CDMA zones. The exact mapping of the N_{z} output ports to the input ports of IFFT module 350 may be reconfigurable depending on which particular orthogonal sub-carriers the CDMA type signals are to be transmitted.

In second portion 390, encoded data symbols are modulated by modulator 340 using well-known modulation techniques, such as BPSK, QPSK, 8PSK, 16QAM and 64QAM, to convert the data symbols into K modulation symbols Sk which are then provided as input to S2P converter 345, where K≦N. S2P converter 120 outputs parallel streams of modulation symbols which are provided as inputs to one or more ports of IFFT module 130 associated with orthogonal sub-carriers over which the encoded data symbols are to be transmitted.

In IFFT module 350, an inverse fast Fourier transformation is applied to the modulation symbols Sₖ and to pre-coded chips (i.e., output of pre-coder) to produce a block of chips cₙ, where n=0, . . . , N_{FFT}−1. Cyclic prefix inserter 360 copies the last N_{cp} chips of the block of N_{FFT} chips and prepends them to the block of N_{FFT} chips producing a prepended block. The prepended set is then filtered through time domain filter 150 and subsequently modulated onto a carrier before being transmitted.

Although the present invention has been described in considerable detail with reference to certain embodiments, other versions are possible. Therefore, the spirit and scope of the present invention should not be limited to the description of the embodiments contained herein.

1. An apparatus for use in a wireless communications system comprising:
a transmitter for transmitting a first signal type over a first orthogonal sub-carrier set, and for transmitting a second signal type over a second orthogonal sub-carrier set, the first signal type being a signal processed in accordance with code division multiple access and orthogonal frequency division multiple access techniques, the first and second signal types being different types.

2. The apparatus of claim 1, wherein the transmitter comprises of:
a precoder for performing a transform operation on an input vector in a time domain into an output vector in a frequency domain, wherein the input and output vectors comprise of N code multiplexed chips and are associated with the first signal type.

3. The apparatus of claim 2, wherein the precoder is a discrete Fourier transformer which uses a discrete Fourier transform matrix of size N×N to transform the input vector.

4. The apparatus of claim 2, wherein the precoder uses an identity matrix to transform the input vector into the output vector.

5. The apparatus of claim 2, wherein the precoder uses a matrix which allows for preequalization techniques to be applied to the transform operation.

6. The apparatus of claim 2, wherein the transmitter comprises:
an inverse fast Fourier transform module for applying an inverse fast Fourier transformation on X inputs to produce a block of X chips, wherein the X inputs comprises of the output vector and modulation symbols associated with the second signal type.

7. The apparatus of claim 6, wherein the transmitter comprises:
a cyclic prefix inserter for prepending Y chips from the block of X chips to the block of X chips to produce a prepended block.

8. The apparatus of claim 7, wherein Y corresponds to a spreading factor used for pilot symbols.

9. The apparatus of claim 1, wherein the second signal type being a signal processed in accordance with orthogonal frequency division multiple access techniques.

10. The apparatus of claim 1, wherein the first orthogonal sub-carrier set comprises of a plurality of disjointed sub-sets of first orthogonal sub-carriers.
